(19) United States
(12) Patent Application Publication
(10) Pub. No.: US 2021/0218631 A1
(43) Pub. Date: Jul. 15, 2021

(54) SYSTEM FOR IMPLEMENTING A DATA LINK LAYER PROTOCOL IN A COMPUTE HOST

(71) Applicant: EOS Defense Systems USA, Inc., Huntsville, AL (US)

(72) Inventors: Michael K. Bugenhagen, Santa Clara, CA (US); Sunil Praful Shah, San Jose, CA (US); Ranjit Vadlamudi, San Jose, CA (US); Mark B. Saxelby, Milpitas, CA (US); Abelino C. Valdez, Tracy, CA (US)

(21) Appl. No.: 17/212,975

(22) Filed: Mar. 25, 2021

Related U.S. Application Data
(63) Continuation-in-part of application No. 16/802,457, filed on Feb. 26, 2020.
(60) Provisional application No. 62/994,849, filed on Mar. 26, 2020.
(60) Provisional application No. 62/811,500, filed on Feb. 27, 2019.

(51) Int. Cl. H04L 12/24; H04L 29/06

(52) U.S. Cl. CPC H04L 41/0896; H04L 63/02; H04L 69/18; H04L 41/0886

(57) ABSTRACT

Novel tools and techniques are provided for implementing a data link protocol (DLP) resource as a user managed cloud resource with compliance tools, automated service delivery, federate-able cloud single sign-on, and agile resource integration. A method for implementing a telecommunication network protocol in an application layer includes establishing, at an application layer, data traffic between first and second DLP nodes. Each DLP node may be implemented at a processor, a virtual switch, or a software application. Each DLP node may include a slow agent and a fast agent. The method may also include determining that the data traffic needs a control message. The method may also include generating the control message at the application layer and injecting the control message to the header of a DLP frame. The DLP frame does not include the payload. The DLP frame is transmitted from the first DLP node to the second DLP node.

### CROSS-REFERENCE TO RELATED APPLICATIONS

This application is a continuation-in-part of U.S. patent application Ser. No. 16/802,457, filed on Feb. 26, 2020, which claims priority to Provisional Patent Application Ser. No. 62/811,500, filed on Feb. 27, 2019. This application also claims priority to Provisional Patent Application Ser. No. 62/994,849, filed on Mar. 26, 2020. The subject matter of all of these applications are incorporated herein by reference in their entirety.

### TECHNICAL FIELD

This description relates to control plane agents and protocols in a telecommunication network, such as in the data link layer.

### BACKGROUND

Free Space Optics can transmit at extremely high rates but have a vulnerability to short duration transmission interruption caused by atmospheric impairments or objects interfering with the beam. Conventionally, re-transmission occurs at other layers than the data link layer such as the physical layer or the Internet Protocol layers. High-speed re-transmission occurring at the physical layer is problematic due to vendor chip inter-operability, and the cost of changing optics to upgrade or improve the transmission facilities. Transport layer protocols such as TCP (transmission control protocol) have flow level transmission correction, however, TCP mechanisms are impacted by round-trip delays, and packet loss and use throughput throttling with exponential back-off before restoring throughput to the flow. These methods are both crude and too lengthy to provide transmission control over a wireless or FSO link and are also unsuitable due to the impacts on the service state machines that are reacting in the milliseconds duration. These mechanisms could also create race conditions and low-quality services for any real-time communication across a link that suffers packet loss such as FSO, and unregulated wireless spectrum.

With the advent of higher speed Central Processing Units that can run at “line rate” (transmission rates) in the gigahertz speed, Network Processing Units (NPU) and more programmable data path functions and applications have emerged and are now capable of replacing dedicated Application Specific Integrated Circuits (ASIC). This new programmable environment allows for functions of the data link layer performing at rates normally only viable at the physical transmission layer.

### SUMMARY

Novel tools and techniques are provided for implementing a data link protocol (DLP) resource as a user managed cloud resource with compliance tools, automated service delivery, federate-able cloud single sign-on, and agile resource integration. In some embodiments, a method for implementing a telecommunication network protocol in an application layer is described. The method may include establishing, at an application layer, data traffic between a first data link protocol (DLP) node and a second DLP node. Each DLP node may be implemented at a processor, a virtual switch, or a software application. Each DLP node may include a slow agent and a fast agent. The slow agent is configured to transmit data payloads through Ethernet frames and the fast agent is configured to transmit control messages through DLP frames. Each DLP frame includes a header only without a payload and the header carrying a control message. The method may also include determining, at the software application of the first DLP node, that the data traffic between the first and second DLP nodes needs a control message. The method may also include generating the control message at the application layer and injecting the control message to the header of a DLP frame. The DLP frame does not include the payload. The DLP frame is transmitted from the first DLP node to the second DLP node.

In yet another embodiment, a non-transitory computer readable medium that is configured to store instructions is described. The instructions, when executed by one or more processors, cause the one or more processors to perform a process that includes steps described in the above computer-implemented methods or described in any embodiments of this disclosure. In yet another embodiment, a system may include one or more processors and a storage medium that is configured to store instructions. The instructions, when executed by one or more processors, cause the one or more processors to perform a process that includes steps described in the above computer-implemented methods or described in any embodiments of this disclosure.

### BRIEF DESCRIPTION OF DRAWINGS

Embodiments of the disclosure have other advantages and features which will be more readily apparent from the following detailed description and the appended claims, when taken in conjunction with the examples in the accompanying drawings, in which:

FIG. 1 is a block diagram of a system environment of an example telecommunication network, according to an embodiment.

FIG. 2A is a block diagram illustrating an example framework of network nodes in a telecommunication network, according to an embodiment.

FIG. 2B is a block diagram illustration a reference system architecture a data link protocol (DLP) framework, according to an embodiment.

FIG. 2C is a conceptual diagram of the two message agents in the DLP framework, and the message bus or network that would ensue when placing those message agents on a computing or host platform, according to an embodiment.

FIG. 3 is an illustration how and where a “frame based” DLP agent could be implemented on a computing platform or host, according to an embodiment.

FIG. 4 is an illustration how and where a “header based” DLP agent could be implemented on a computer platform or host, according to an embodiment.

FIG. 5 is reference architecture diagram showing the different layers in a computing platform or Host where the DLP protocol functions can be implemented, according to an embodiment.

FIG. 6 shows a reference implementation of supporting a DLP aware application and how that interacts with the other layers inside the computing host, according to an embodiment.

FIG. 7 is shows how the DLP header agent handles messages at end points, and intermediate locations along the DLP path, according to an embodiment.

FIG. 8 is a depiction the DLP fields to support application, and function messaging inside the reserved DLP header space, according to an embodiment.

FIG. 9 depicts a computing host that utilizes the DLP framework only on the transport data bearer plane or data plane under the computing layer, according to an embodiment.

FIG. 10 depicts a computing host that utilizes the DLP framework at both the transport data plane, and virtual connectivity plane of the host, but not the computing virtual infrastructure layer of the host, according to an embodiment.

FIG. 11 depicts a computing host that supports DLP based applications and has DLP header and OAM capabilities at all layers, according to an embodiment.

FIG. 12 is a block diagram illustrating components of an example computing machine, according to an embodiment.

### DETAILED DESCRIPTION

The figures (FIGs.) and the following description relate to preferred embodiments by way of illustration only. One of skill in the art may recognize alternative embodiments of the structures and methods disclosed herein as viable alternatives that may be employed without departing from the principles of what is disclosed.

Telecommunication and cloud computing often co-utilize the Ethernet and the internet protocol (IP) layer for transporting data along the local area network (LAN), and wide area network (WAN) paths. However, data protocols such as Ethernet were originally designed for short distance networks such as LAN but have been cross utilized in longer distance networks such as WAN where transmission states become important to the application layer. Various facets of delay and transmission line states have not been thoroughly addressed in the IP layer that is typically used for service delivery. Consequently, customers' needs at the application layer have gone unaddressed.

In various embodiments, a data link protocol (DLP) is added to a host in various manners of integration. The specific DLP being added may include a modular DLP that provides packet loss recovery across multiple disparate links. The modular DLP may address critical application needs that are not addressed by traditional Ethernet and IP protocols. The protocol may take the form of a framework that adds a header to user information flows as the frame enters the link. The header may be removed as the frame egresses the link. The protocol has two message agents that are used to transfer information across the link. The two agents may be a slow agent and a fast agent. The DLP slow agent uses frames to transfer information while the DLP fast agent uses the inserted header space or packet-based frames to transfer information at the line rate of the links being supported. The DLP framework supports traffic control and application functions assigned to each flow. The DLP nodes may use the slow and fast agents via a message interpreter function to transfer information between the functions when paired at the ends of the link and when paired externally to the protocol when required. The DLP framework allows a customer to map flows from the customer's LAN or WAN into specific links and quality of service (QoS) flows that each have their own level of transport frame loss recovery and multi-path redundant flow protection in order to provide a higher connection resiliency.

Furthermore, the use of header-based messages is traditionally a time division multiplexing (TDM) feature that is lacking in the Ethernet and IP protocols. The lack of header-based messages has caused performance issues for applications that require path selection information for sub-second critical activities such as card swipes, financial trading, wireless backhaul controls, Internet of Things (IoT) or artificial intelligence controls, and so on.

Various embodiments provide more robust link protocols for applications and control systems in computing and cloud type systems in order to close the existing data protocol gaps.

The present disclosure in general is related to methods, systems, and apparatuses for implementing a DLP in a cloud host in order to provide speed-resilient transport facilities for applications and functions. An example implementation leverages a DLP header in the host architecture along with DLP message agents that are used to send information. The function of adding the header and supporting the message agents (fast agent and slow agent) in the host element can take place in the network processor, virtual switch, network interface layer, the application layer, or the computing layer. Given that the location of the DLP support can be at different layers, the resulting functionality can vary from DLP-aware applications to having the DLP serve as a cloud host to manage resources in a virtual switch layer. The DLP may also serve as a host resource if the DLP is on the network interface layer. In various accounts the specialized DLP functionality provides unique link resiliency for even non-DLP aware applications.

The implementation method utilizes a cloud infrastructure and virtualization layer host function. An embodiment may apply DLP functions in the host or cloud framework as resources in the host. The DLP functions can be implemented at various layers in a host. The system can include an integration of the DLP into the cloud host or computing node framework.

Various embodiments provide tools and techniques for implementing the DLP on a computing node, between computing nodes, or between an end device and a computing node. Given DLP is a link based protocol, DLP can be deployed on dedicated devices, nodes, and even entire facilities. For the purpose of this application, a “computing node” may include any of these and other implementations. The implementation of DLP, more particularly, is related to methods, systems, and apparatuses for implementing the DLP header, message agents, messages and other functions in various ways at different layers of computing, including application specific integrated circuit (ASIC), network interface card, network processing unit (NPU), virtual switch, physical switch, and other various locations.

In various embodiments, the DLP functions may be placed on computing node or platform to provide applications with resilient transport across multiple technology links, such as a wireless channel, free space optics channel, multiple carrier channels, or a combination of any of these connectivity methods. In some embodiments the DLP header switching and the message handling functions are implemented above the network layer of the platform up into the virtualization, switching, or bus layers of the platform. In some embodiments, the DLP header switching and the message handling function may even be implemented into the application layer where an application map is directly carried into a DLP header and messaging agents.

In some embodiments, the application uses the sub-second performance metrics and states contained within the DLP agents to make application and control decisions, regardless of where the DLP message agents and headers are located.

In some embodiments, a system is aware of the DLP technology and does not simply rely on the underlying resilient transport.

In some embodiments, an application is DLP aware and classifies its own traffic into flows with DLP headers that are treated by transmission control functions such as multi-path, automatic repeat request (ARQ), package loss correction, etc.

In some embodiments, the DLP agents utilize multiple WAN links from different providers or technologies. The DLP agents on the WAN side provide computing node to computing node transport protection.

In some embodiments, the DLP agents utilize multiple LAN links to provide highly resilient connectivity to end devices, sensors, IoT, AI, robotics, other control agents, or nodes.

In some embodiments, applications use the DLP reserved message header space for application-to-application control messaging.

In some embodiments, a telecommunication system using a DLP protocol is described. The telecommunication system having a fast agent and a slow agent that may be implemented in an execution environment as a virtual switch or as a part of hardware or software combination that can be implemented in a processor such as an NPU.

In some embodiments, an application and virtual switch can create and place a header and have the information for the network performance management inside the application itself. This means multiple DLP header functions may be placed in a serial path.

In some embodiments, DLP messages may be sent with gapping so that an application can use some DLP frames but not all the frame to transmit on the fast path. The rest of the available DLP are reserved for other control messages such as ARQ or reserved for downstream nodes. Applications are set to gap or only use a portion of the available frames per bearer path so other agents have some unused frames.

In some embodiments, an interpreter function works with an in-line header where the DLP fast agent reads the header to see if the header is used. The header may have the option of an “unused” attribute. The fast agent reads a header and may insert or extract a message.

In some embodiments, new header space for messages from other applications may be inserted as part of an Ethernet frame.

In some embodiments, the DLP transport protocols are processed on both sides of an application in an application layer. The processor (e.g., NPU) sends native flows to the computing node, but has DLP on each side.

In some embodiments, a DLP stack on a virtual switch (which may be a virtual machine switch scheduler) is disclosed. The virtual-switch is capable of performing the DLP protocols (such as having the fast agent). Network performance management is provided up to the orchestration layer without requiring external developer APIs to allow legacy applications to use DLP protocols.

In some embodiments, a DLP-aware application has the performance knowledge in the application. Customers can put application on third party platforms (e.g., public cloud) when those third party platforms do not have DLP.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Example System Environment

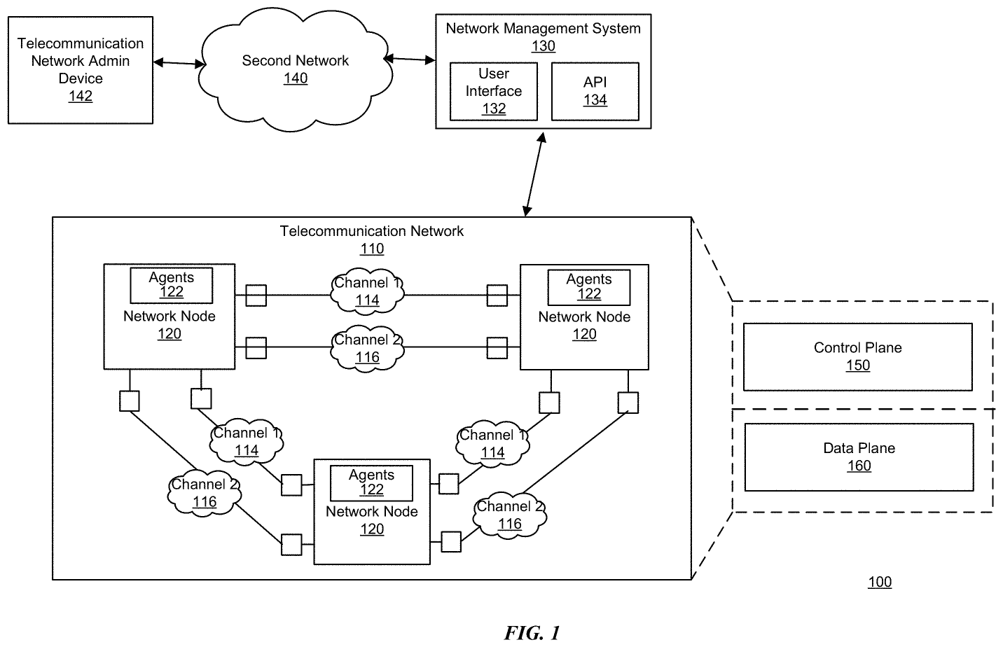

FIG. 1 through FIG. 11 illustrate various features related to methods, systems, and apparatuses for implementing a data link protocol (DLP) as a part of the infrastructure layer, switching layer, or application layer of a cloud host, a computing node, or an end device. A computing host may also be referred to as a computing node.

FIG. 1 is a block diagram illustrating a system environment 100 of an example telecommunication network 110, according to an embodiment. The system environment 100 includes the telecommunication network 110, which includes two or more network nodes 120, a network management system 130, a second network 140, and a telecommunication network administrator device 142. In various embodiments, the system environment 100 may include fewer or additional components. The system environment 100 may also include different components. The components in system environment 100 may be deployed in one or more physical devices and embodied in software, firmware, hardware, or any combinations thereof.

Telecommunication network 110 may be any communication network that transmits data and signals by any suitable channel media such as wire, optics, waveguide, radio frequency, or another suitable electromagnetic medium. The telecommunication network 110 can be of any scale from near-field to a satellite wireless network, including local area network (LAN), metropolitan area network (MAN), wide area network (WAN), long-term evolution (LTE) network, or another suitable communication network whose scale and area of coverage may not be commonly defined. The components in telecommunication network 110 do not need to be confined in the same geographic location. For examples, the network can be established with nodes that are distributed across different geographical locations. Also, some of the nodes may be virtualized. The telecommunication network 110 includes two or more network nodes 120 that communicate with each other through one or more channels 114, 116, etc. While three example network nodes arranged in a ring are shown in FIG. 1, telecommunication network 110 can be in any topologies, such as point-to-point, star, mesh, chain, bus, ring, and any other suitable, regular or irregular, symmetric or not, cyclic or acyclic, fixed or dynamic (e.g., with one or more network nodes 120 moving) topologies. The telecommunication network 110 may include wireless communication between network nodes 120 that are carried by (e.g., mounted on, integrated in, or otherwise embedded) building sides, towers, other structures, surface ships, floating platforms at sea, submersible vehicles, ground vehicles such as cars or trains, airborne platforms such as airplanes, balloons, dirigibles, and other fixed- or non-fixed-wing aircraft, space platforms such as satellites, space stations, manned space vehicles, space probes, and other space vehicles.

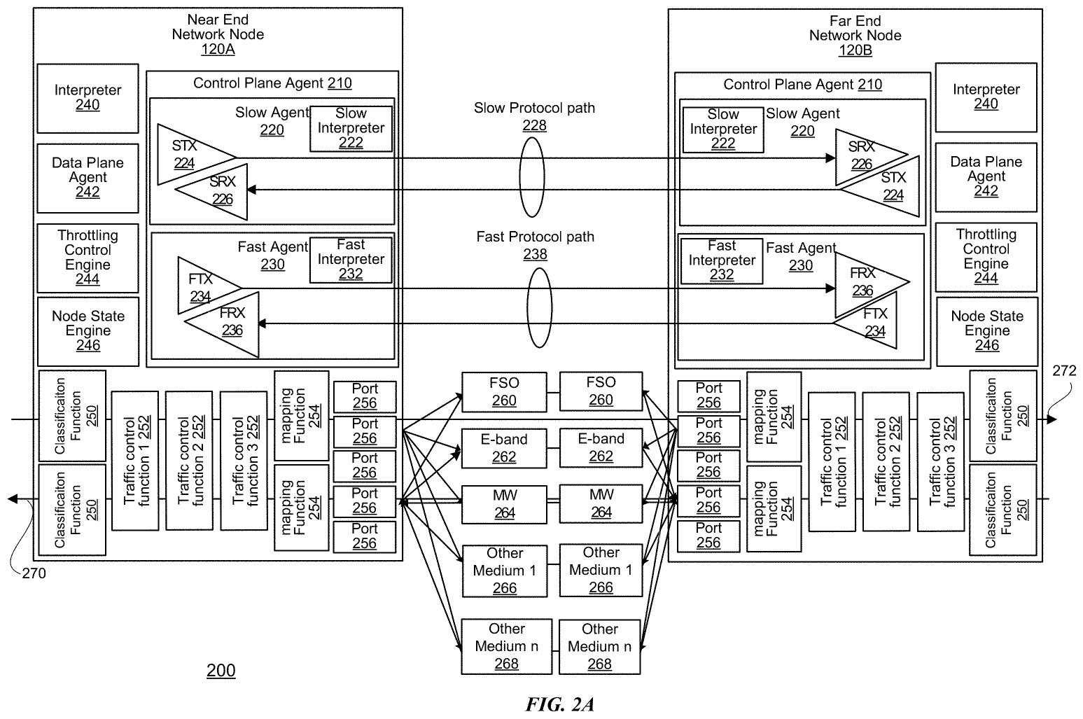

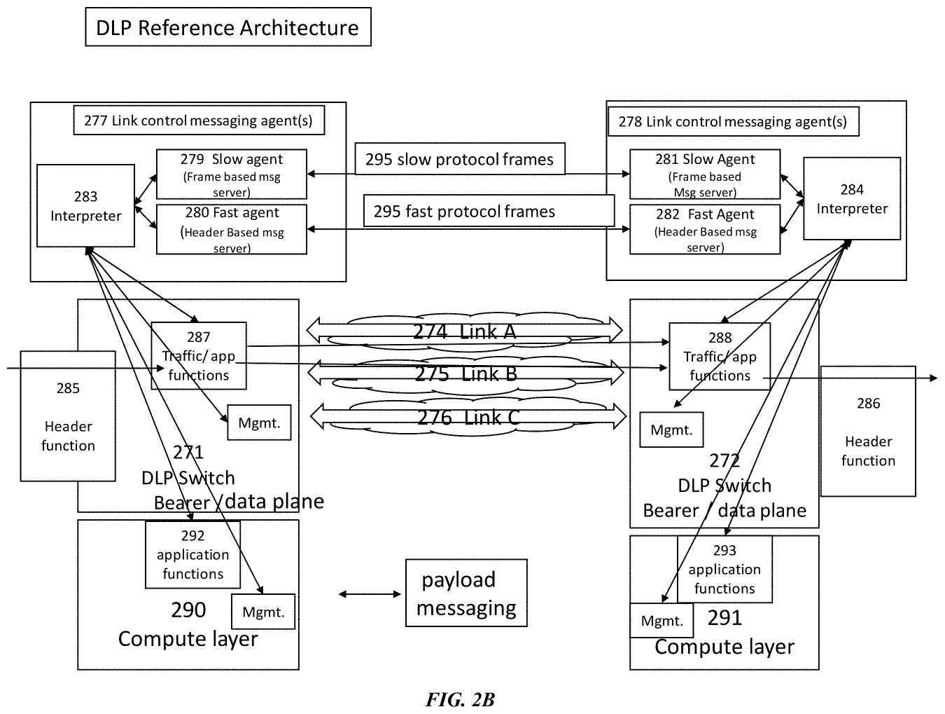

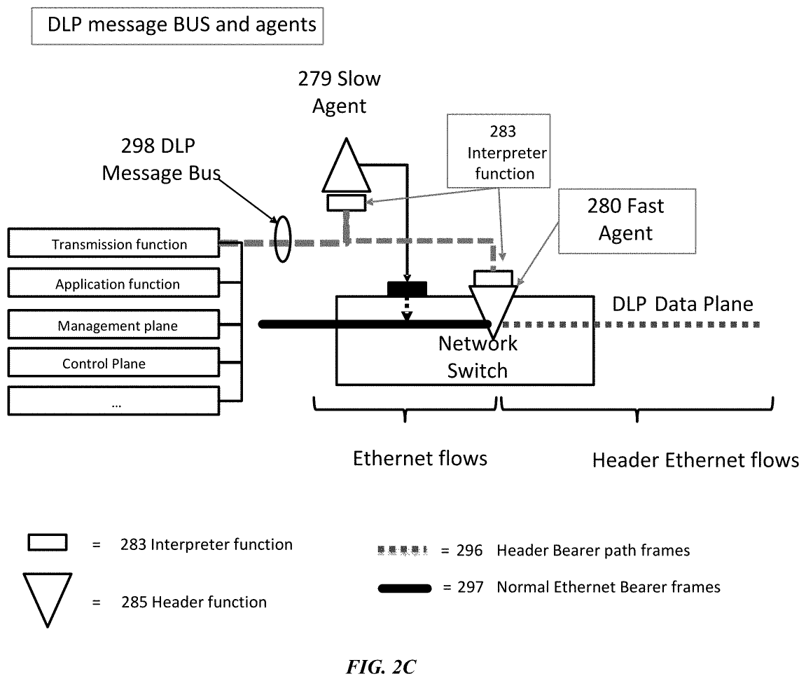

Network nodes 120 may be any suitable distribution points, redistribution points, or endpoints of telecommunication network 110. Network nodes 120 may also be referred to as simply nodes 120 and may take the form of a communication instrument, a base station, a physical node, a virtual switch, a computing node, a cloud resource, or any suitable computing device that is equipped with one or more network protocols. Each network node 120 may include one or more agents 122. Different types of agents 122 in a node 120 will be discussed in further detail below with reference to FIG. 2A. Network nodes 120 can be any suitable data communication equipment for encoding and transmitting data frames in one or more physical layer channels. Depending on embodiments, one or more network nodes 120 can take form of gateways, routers, switches, hubs, modems, base stations, terminals, wireless access points, Internet of Things (IoT) devices, etc. that may be carried by fixed structures or mobile equipment such as satellites, vehicles, autonomous vehicles, drones, or portable electronic devices. In other words, a node 120 may be any suitable infrastructure or equipment that may be used to transmit or re-distribute data to another node 120. The node may also be virtualized and a software-implemented node that can be part of a computing device or a cloud resource. Each node 120 may communicate with another node 120 through one or more channels 114, 116, etc. of similar or dissimilar technology types. Channels 114 and 116 can be of any suitable channel media such as free space optical (FSO) communication, E-band, microwave, mobile wireless, fixed wireless, a wired connection, an Ethernet-based transport facility, or another suitable medium. A channel may also simply be the Internet. Channel 114, channel 116, and other channels may also be using the same medium but with different frequencies such as radio frequency using Wi-Fi frequency band, LTE frequency band, ultra-high frequency (UHF) band, etc. Also, the channels 114 and 116 may also use the same type of medium. For example, channel 114, channel 116, and other channels may be several FSO channels with spatial diversity. While all three of the network nodes 120 in FIG. 1 are shown to be connected by channel 114 and channel 116, any pair of network nodes 120 in telecommunication network 110 may be communicated with each other in channels that are different from those used in another pair of network nodes. For example, FSO may be available between some of the network nodes 120, but not between every node 120.

Telecommunication network 110 may be divide logically, structurally, and/or architecturally into a control plane 150 and a data plane 160. The control plane 150 and data plane 160 are different functional layers of the telecommunication network 110 and may have separate or shared hardware and architecture, but may be separately controlled and maintained through software and sometimes certain separate hardware. Data plane 160 may be the part of the telecommunication network 110 that is used to transmit data payloads. Data payloads are live data traffic that is transmitted by network users through the telecommunication network 110. For example, website data, emails, multimedia data, and other suitable Internet packets may be transmitted through the telecommunication network 110 and are examples of data payloads. Channels 114 and 116 that are used by the data plane 160 are often operated at the line rate or close to the line rate to enable data payloads to be transmitted as fast as possible through telecommunication network 110. Data plane 160 may also be referred to as the bearer plane. Data plane 160 may contain header-based flow identifiers.

Control plane 150 may be a function layer of the telecommunication network 110 that is used to transmit information related to changes, additions, or removal of various settings and protocols of the telecommunication network 110. For example, control plane 150 is used to transmit control messages that are used to adjust the settings of one or more network nodes 120, the entire telecommunication network 110, certain channels 114 and 116, etc. Messages intended for the control plane 150 may be referred to as control plane messages, which may carry parameters and/or instructions to change one or more settings of a component in the telecommunication network 110. One example of a control plane message may be a message that carries instructions related to a traffic control function. Another example of a control plane message may include a packet or any messages that are intended for layers that are higher than data link layer. A control plane message may also be transmitted from a node 120 to the network management system 130 and carry state information (e.g., status information) or feedback information of a component of a node 120. Types of control plane messages may include operational messages, administration messages, maintenance messages, provisioning messages, troubleshooting messages, etc. The protocol agents 122 may include settings of a component in the telecommunication network 110. The settings may be associated with traffic control functions (TCFs), flow classification functions, mapping functions, quality of service settings, throttling management, traffic management, error control mechanisms, error correction mechanisms, data link layer protocols, multiplexing protocols, delay protocols, rate limits, scheduler types, port settings, virtual LAN (VLAN) settings, physical layer encoding protocols, physical layer error correction schemes, etc. Control plane messages are distinct from data payloads transmitted in the data plane 160 and are used to control the telecommunication network 110. It should be noted that the term control plane message may apply to protocol, configuration, and signaling messages between the agents (both fast and slow), and between the TCFs which can be mapped or encoded into the fast and slow agents.

Control plane 150 used in this disclosure may include both a control plane and a management plane. For example, in some embodiments, a control plane may handle control and protocol messages that are intended for sharing among network nodes 120 (which may be commonly referred to as east and west bound messages). A management plane, on the other hand, may handle control and protocol messages that are originated from a device outside the telecommunication network 110 or from a third party through the network management system 130 (which may be commonly referred to as north bound messages). In the embodiments that further divide control plane 150 into a control plane and a management plane, the messages intended for the management plane may be referred to as operations, administration, or management (OAM) messages. However, for embodiments that further divide control plane 150 into a control plane and a management plane, the term control plane message may include both messages intended for the control plane and the messages intended for the management plane, including OAM messages.

Network management system 130 may be a server or any computer that is used to manage the telecommunication network 110. The network management system 130 may transmit one or more administration, control and configuration messages to a node 120. In some embodiments, the network management system 130 may directly communicate with every node 120 in the telecommunication network 110. In another embodiment, a node 120 that received the messages may propagate the messages to one or more other network nodes through the control plane 150. The control plane messages may be intended for all network nodes 120 or a subset of network nodes 120. The network management system 130 may provide a user interface 132 for a network administrator (e.g., a customer that purchases or leases the infrastructure of telecommunication network 110) to control and adjust one or more settings of telecommunication network 110. The user interface may take the form of a graphical user interface (GUI) to provide visual information and data for the network administrator. The network management system 130 may also include an application programming interface 134 (API) for a network administrator to use programming languages to communicate with the network management system 130. The network management system 130 may also communicate with third party systems over which the network administrator device 142 may receive information relevant to network components managed outside of the network management system 130.

A network administrator may use a telecommunication network administrator device 142 to communicate with the network management system 130 through a second network 140. The telecommunication network administrator device 142 may be one or more computing devices such as desktop computers, laptop computers, personal digital assistants (PDAs), smartphones, tablets, wearable electronic devices (e.g., smartwatches), smart household appliance (e.g., smart televisions, smart speakers, smart home hubs), Internet of Things (IoT) devices or other suitable electronic devices. The telecommunication network administrator device 142 may communicate with the network management system 130 through the user interface 132 and/or API 134. The second network 140 may be any suitable network such as the Internet, 4G, LTE, 5G, LAN, or a direct line. Telecommunication network 110 may or may not be part of the second network 140. In some embodiments, a network administrator may remotely control the settings of the telecommunication network 110 through sending commands via the Internet to the network management system 130. For example, a network engineer of a telecommunication company may control the telecommunication network 110 using API 134 through the Internet at the engineer's normal place of work. In another embodiment, a network administrator may be local to the telecommunication network 110 and he may control the network 110 through a local area network (e.g., WI-FI) or even a direct ethernet cable. As discussed in further detail below with reference to the section “Management of Telecommunication Network” below, a network administrator may dynamically change settings of telecommunication network 110.

FIG. 2A is a block diagram illustrating the architecture of two example network nodes 120 in the telecommunication network 110, according to an embodiment. FIG. 2A illustrates an example framework 200 for carrying out various functions and protocol in this disclosure, according to an embodiment. The two example network nodes 120 may be referred to as a near end network node 120A and a far end network node 120B. Near end network node 120A represents a transmitting side of a network and far end network node 120B represents a receiving side of the network. In a fully duplex network, near end and far end network nodes may be equivalent. Unless further specified, these network nodes may simply be referred to as network nodes 120. Near end network node 120A and far end network node 120B may also simply be referred to as a first network node and a second network node. For a message that is received at a far end network node 120B, the message may be intended for the far end network node 120B and/or intended for another network node 120 in the telecommunication network. If the message is intended for the far end network node 120B, the far end network node 120B will process the message. If the message is intended for another network node 120, the far end network node 120B will become the near end network node 120A for the next round and forward the message to another network node 120. The message can be a control message or a data message.

A network node 120 may include a control plane agent 210, an interpreter 240, a data plane agent 242, a throttling control engine 244, a node state engine 246, and ports 256 that include or are connected to channel equipment (e.g., antennas, laser transmitters, waveguides, cables) for transmission of signals. The control plane agent 210 may be a data link layer agent. In various embodiments, a network node 120 may include fewer or additional components. A network node 120 may also include different components and the functionality of each component may also be distributed to another component or among other components. Each component may be implemented using a combination of software and hardware. For example, each network node 120 may include memory for storing instructions that define one or more software engine and one or more processors for executing the instructions to perform one or more processes described in this disclosure.

A control plane agent 210 is a data link layer agent that may be implemented as a software engine that is executed on one or more types of processors for different computations and functionalities. The control plane agent 210 manages the protocols, traffic control functions, and frameworks for transmitting and routing control plane messages to various network nodes 120. The control plane agent 210 may include a slow agent 220 and a fast agent 230 that may be run on the same or different types of processors to transmit and process messages at different speeds. For example, in some embodiments, the slow agent 220 includes instructions that are executed on a generic processor such as a central processing unit (CPU) to process and route regular control plane messages. The fast agent 230 includes instructions that are executed on a specialized processor such as a network processing unit (NPU) that may be also used by the data plane. In another embodiment, the fast agent 230 may be run on a field-programmable gate array (FPGA) or another suitable processor. Control plane messages processed by the NPU may be expedited and transmitted using a fast protocol path 238 at the line rate of a channel or the rate of data plane 160. The slow agent 220 may transmit messages using a slow protocol path 228 at the rate of the control plane 150 that is set by the administrator of the telecommunication network 110. The slow agent 220 includes a slow transmitter function 224 and a slow receiver function 226. The fast agent 230 includes a fast frame header insertion function 234 and a fast frame header retrieval function 236.

Interpreter 240 may be implemented as a software engine that is executed on one or more types of processors for deciding various protocols, functions, ports, channels, quality of service (QoS) requirements. The interpreter 240 may be run on a processor separate from the processors used by slow agent 210 and the processor used by fast agent 230. A control plane message may include mapping information associated with how the control plane message should be transmitted. For example, part of the mapping information may take the form of metadata of the control plane message. In some cases, part of the mapping information may also be inherent in the type of control plane message and/or sender of the control plane message. Interpreter 240 may receive and map TCF-related control plane messages to the slow agent 220 or the fast agent 230 for transmission to a far end network node 120B. At the far end network node 120B, the slow agent interpreter 222 or the fast agent interpreter 232 reverses the process to map the TCF-related control plane messages to the related TCFs.

The control plane agent 210 controls and holds the configuration for the flow mappings from the classification function 250 to map information payload and control plane messages into a path (e.g., one or more channels using one or more ports 256) and QoS treatment to provide the basis for applying switching, mapping, and/or traffic control to specific traffic classification. The control plane agent 210 may also use mapping functions to provide the system for implementing routing of network traffic across one or more network nodes 120 or utilization of one or more network nodes 120 based on classification and QoS treatment of traffic flows. The control plane agent 210 may also determine one or more traffic control functions 252 (e.g., the type of automatic repeat request (ARQ), repetitive messages sent across different channel media, etc.) for information payload and control plane messages. In some embodiments, interpreter 240 may include a slow interpreter 222 that is run on a CPU and a fast interpreter 232 that is run on an NPU.

The fast agent 230 may be implemented in the data plane and be a part of the data plane agent 242, which may be a data link layer agent that may be implemented as a software engine that is executed on one or more types of processors. The data plane agent 242 transmits data payloads of the telecommunication network 110 and control plane messages with special headers that are treated as part of the data traffic. In some embodiments, to increase the speed of transmission and data processing of information payloads, the data plane may be run on an NPU. The fast agent 230 may be used to transmit control messages but use data plane resources to increase the speed of transmission.

The throttling control engine 244 controls the traffic of one or more channels of a network node 120. In some cases, throttling control engine 244 may limit the bandwidth of a particular user or a particular channel to ensure the traffic associated with the user or channel does not overburden the system. The node state engine 246 monitors the status of a network node 120, including the status of ports, links, the control plane and the data plane. The node state engine 246 also monitors the status and activities of each channel. The throttling control engine 244 may provide flow pushback to ports based on the status information provided by node state engine 246.

For example, the throttling control engine 244 obtains state information on each physical and/or logical link on the network nodes 120, or the node uses a third-party channel, for the purposes of modifying flow rates through the DLL link. The throttling control engine 244 makes decisions based on the state information, information in the configuration of the services held in the data plane 160, settings on the control plane agent 210 on how to perform flow control, or push back to restrict bandwidth rates at the network side of a network node 120 when congestion situations are encountered. The network-side port may provide end-to-end flow information. The network-facing ports may use mechanisms such as PAUSE in mapping and pause detection function, and other IP or Ethernet type congestion signaling to communicate flow control is needed by the network nodes 120.

In the embodiment shown in FIG. 2A, the network nodes 120 may communicate with each other through more than one channel. Example channels may include FSO communication 260, E-band 262, other radio frequency such as microwave (MW) 264, and additional channel media 266 and 268. The channels 260, 262, 264, 266, and 268 in FIG. 2A are examples of channels 114 and 116 in FIG. 1. The particular types of channel media (e.g., FSO and E-band) are merely shown in FIG. 2A as examples. Channels between two network nodes 120 in any embodiments may include zero to multiple FSO 260, zero to multiple E-band 262, etc. Also, among network nodes 120, there can be different types of channels between any two network nodes 120. For example, some network nodes 120 may have the same channels, while other network nodes 120 may have different channels in a telecommunication network 110. In a telecommunication network 110, a pair of network nodes 120 may be fully duplex, as represented by arrows 270 and 272. However, in some embodiments, some of the network nodes 120 may also be half duplex or simplex.

The classification functions 250, traffic control functions 252, and mapping functions 254 may include customizable variables that may be stored in a memory of a network node. Those functions may be adjustable to allow a network administrator to quickly change the settings of network nodes 120 so that those functions become “hot modifiable.” The agents, engines, and other configurations of network nodes 120 may be configured by the network management system 130 by adjusting those functions. Those functions affect how a control plane message or an information payload is transmitted across the telecommunication network 110 such as the channel used, the ARQ used, etc. For example, a telecommunication network administrator device 142 may send a new transport control function or a change in a transport control function to telecommunication network 110 through network management system 130.

The framework 200 of a network node 120 shown in FIG. 2A allows the telecommunication network 110 to implement mapping and management of network traffic across one or more network channels and nodes 120. The framework can be used to address issues with FSO channel stability, but the framework can be applied to different types of data link layer functions, link aggregation, SDN, NFV, IoT, Cloud, other solutions that use VPN, and link protocols where trunk or link aggregation type methods are implemented. The framework allows a telecommunication network 110 to perform various functions required to classify, map and un-map traffic into link flows, while providing the ability to add and subtract traffic control functions on-demand or at will.

The implementation method may utilize transmission, switching, and aggregation nodes architectures and be deployed in a single device or multiple devices. More particularly the method involves traffic classifications, mapping, QoS treatment, and data link layer functions and other functions used across a link or plurality of links to provide better service performance, and the ability to dynamically change the traffic control and mapping functions used on the traffic itself.

The network node 120 implements software-defined, highly configurable, and customizable data link layer transmission and QoS control mechanisms to provide resilience to media subject to packet loss such as FSO and unregulated Wi-Fi. A network node 120 provides management and control plane features that provide fully customizable and extendable QoS treatments for data plane 160 via modularly defined transmission and QoS mechanisms that can be used to maintain and handle traffic flows across one or more channels.

A network node 120 includes a data plane agent 242, a control plane agent 210, a throttling control engine 244, and a node state engine 246 that are used to manage traffic between two network nodes 120. The network node 120 may include various functions such as an event and messaging function, classification, flow control, and pushback function, traffic control functions and link management, and mapping and pause detection functions that cooperate to configure and reconfigure the data plane functions. Those functions may be configured by the network management system 130.

The DLP protocols can be used to send control plane messages via a slow protocol path 228 or a fast protocol path 238, according to an embodiment. A control plane agent 210 may receive or generate one or more control plane messages. A network node 120 may receive a message when the message is transmitted from another network node 120. The message may also be originated from the network node. A control plane message may belong to the control plane 150 that is from a TCF 252. The control plane agent 210 may also receive mapping information associated with how the control plane message should be transmitted. For example, the mapping information may be a set of parameters that are part of the metadata of the control plane message. In some cases, the mapping information includes port information, traffic control functions to be used, and QoS specification. The interpreter 240 determines, based on the mapping information, whether the control plane message is to be sent via the control plane 150 or the data plane 160. The interpreter 240 may make the determination by inputting one or more parameters of the control plane message to the mapping function 254 to decide whether the control plane message is to be sent by which single or plurality of links. In some embodiments, the telecommunication network 110 includes a plurality of channels. The interpreter 240 may determine the states of the channels. The interpreter 240 then determines a mapping of the control plane message based on the mapping information and the states of the channels to determine whether the control plane message is to be sent via alternative paths when link outages occur.

If the interpreter 240 decides that the control plane message is to be sent by data plane 160, the control plane message is processed by the fast agent 230. Fast agent 230 is a control plane agent but uses data plane resources to transmit the control plane message. In response to a determination that the control plane message is to be sent via the data plane 160, the fast agent 230 may first encode the control plane messages. For example, the fast agent 230 may turn the control plane message into a shorter message based on a particular mapping and classification scheme that may be defined in mapping function 254 and classification function 250. The fast agent 230 may insert the shorter message as a structured header in a data plane frame. The data plane frame may or may not include data payload of regular user traffic and a section of the data plane frame is utilized to carry control plane message. For example, in some embodiments, a fast agent frame contains only header without payload so that the frame is small and can be transmitted really quickly. Sometimes the fast agent frame may be transmitted in the middle of two regular payload frames. The data plane frame has a marking signifying that the data plane frame carries the control plane message. In some embodiments, the marking may be part of the header and may assign values based on the control plane message type. In some embodiments, the header may include two sections that are used to encode the control plane message type. The first section may include the path identifier of the control plane message. The second section may include the QoS level identifiers of the control plane message. In some embodiments, the encoded frame (e.g., with a header that is coded with the type of control plane message) may be referred to as a codified frame that is in a specific format. In some embodiments, the specific format of the data plane frame complies with the Ethernet frame standard. In various embodiments, the fast agent 230 may also insert the control plane message or an encoded shorter version of the message into another part of a data plane frame. For example, if a control plane message includes information that may not be easily encoded to fit the space of a header, the control plane message may also be put in the body of the data plane frame.

The network node 120 transmits the data plane frame via the data plane 160 by injecting the data plane frame into a traffic of data payload frames. Data payload frames are normal information traffic of the data plane 160. The data plane frame that carries a version of the control plane message (e.g., the control plane message itself or an encoded shorter version) is identified by the marking. By transmitting a control plane message through the data plane 160, the control plane message can be propagated to other network nodes 120 in the telecommunication network 110 at line rate of a channel or close to the line rate. As a result, control plane messages can be transmitted quickly in the network and various customizable functions, such as a network traffic control function, of the network nodes 120 can become “hot modifiable” by virtue of using the reserved header space and/or different control plane messages.

At a far end network node 120B, the network node 120B receives a plurality of frames transmitted via the data plane 160. The network node 120B determines that one of the received frames includes the marking (e.g., the special header) as the data plane frame that encodes the control plane message. The network node 120B returns the control plane message to a part of a flow of the control plane 150 based on the mapping information associated with the control plane message. The network node 120B may also determine that other frames in the received frames that do not include the marking as the data payload frames and continue to route those data payloads through the data plane 160. In one case, if a marking is found in a data payload frame, the structured header that carries the control plane message is stripped off. The control plane message is forwarded to control plane 150. The rest of the data payload frame is routed through the data plane 160.

If the interpreter 240 decides that the control plane message is to be sent by control plane 150, the control plane message is processed by the slow agent 220. The slow agent 220 generates a control plane frame that encapsulates the control plane message. The network node 120, in turn, transmits the control plane frame via the control plane 150. In some cases, the network node 120 (or a channel of the node) may toggle between two states. In a first state, the data plane 160 has data traffic. In a second state, the data plane does not have data traffic. In the first state, the control plane message may be sent through the data plane 150 by injecting the data plane frame that carries the control plane message into the live traffic. In the second state, the control plane frame may be sent via the control plane 150 or be sent via the data plane 150 during a lapse of data plane traffic.

The network node agents' ability to map messages to the fast or slow agent, combined with the extendibility of interpreter using type and/or other information to add, remove, or adjust TCFs statically or dynamically by the agent or externally via API interfaces, creates a framework that supports a plethora of other network functions outside of data link layer transmission and quality control. Natively the framework can be used to support any data path function. For example, security functions such as encryption functions can be treated as TCFs where functions are configured via the agent by mapping traffic through the agents. The end-to-end security control may be passed through the fast or slow paths via a type of TCF or other delineation. Any paired or standalone (e.g., single end function) function can be treated as a TCF by the agents and the data may be sent as control plane messages. The functions may be added on-demand dynamically provided the function has a TCF type that allows the information to be mapped across one or both of the agents.

The adaptability of the frame in accordance with an embodiment will be apparent to one skilled in the arts of service chaining where a function may be a sub-component of an overall traffic service. The agents can dynamically add and/or remove TCFs, any other applications, or functions from the data plane via re-configuring the mapping elements and the setting up of the interpreter and flow. This enables the framework to host Cloud functionality as part of the protocol, as well as SDN, IoT, AIN, Machine Learning, and AI. Each of these functionalities may use system functions distributed along the transmission path. The framework may be extended to support new functions. The signaling may be mapped to the path best suited for the requirements of the control plane message.

FIG. 2B is a block diagram that illustrates the placement of DLP traffic functions 287 and 288 and classifiers 285 and 286 on a cloud architecture, according to an embodiment. The classifiers 286 and 286 may take the form of header function in the DLP. The traffic functions 287 and 288 and classifiers 285 and 286 may be implemented in computing hosts 271 and 272. The computing hosts 271 and 272 have compute layers 290 and 291, each of which includes its application functions 292 and 293. The computing hosts 271 and 272 also include link control messaging agents 277 and 278. Each link control messaging agent may include an interpreter, a fast agent, and a slow agent. The functions and features of the interpreter, fast agent, and slow agent are similar to the interpreter 240, fast agent 230, and slow agent 220 shown in FIG. 2A. The header function (classifier) 285 maps Ethernet or IP protocol headers into DLP headers for traffic treatment. The Ethernet flows enter the header function (classifier) 285 and are mapped through traffic function 287 that performs functions such as ARQ for packet retransmission. The header function (classifier) 285 may also replicate flows over multiple links 274, 275, and 276. The replicated flows are recombined at the traffic function 288 and then passed on to the next header function (classifier) 286. If data is intended for a computing host, the data is transmitted to compute layer 290.

FIG. 2C is a conceptual diagram illustrating a DLP message BUS and agents, according to an embodiment. The DLP fast agent 280 and the slow agent 279 may receive messages from a computing host function via a message bus 298. The header-based agent is in the host architecture where the DLP header agent (fast agent) is implemented. A network switch may receive a normal Ethernet bearer frame 297. The fast agent 280 or the slow agent 279 use the header function 285 to translate the normal Ethernet bearer frames 297 to header bearer path frame 296. The message is then transferred using DLP data plane. Data related to transmission function, application function, management plane, and control plane may also be transmitted via the header bearer path frames 296. The fast agent 280 or the slow agent 279 uses the interpreter function 283 to create mapping and conversion of header format.

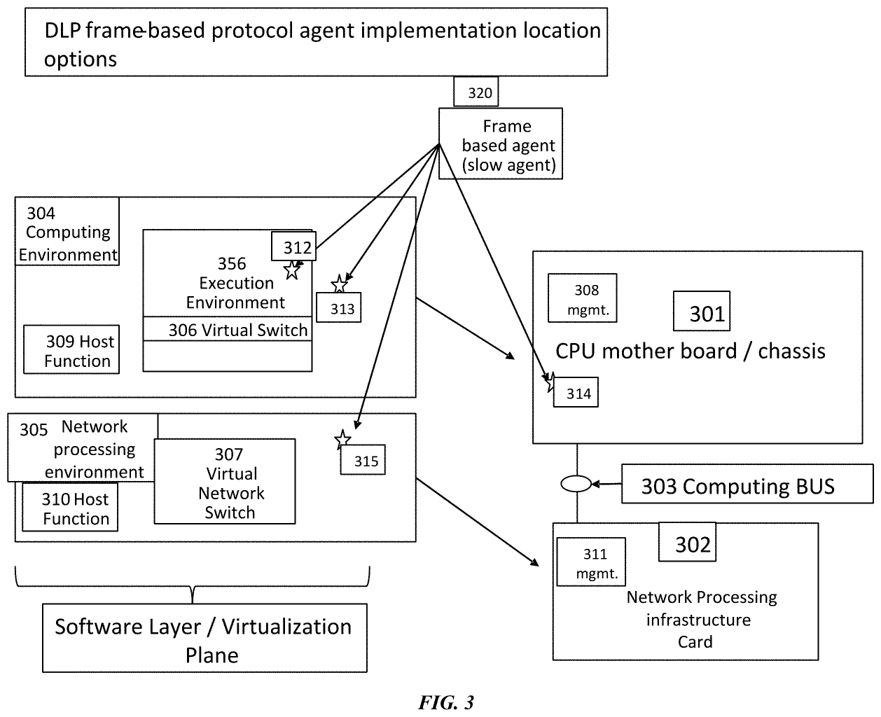

FIG. 3 is block diagram illustrating how a frame-based agent (slow agent) may be implemented in a host computing system, according to an embodiment. The host computing system may include mother board and chassis 301 and CPU 314. The host computing system may also include a network processing infrastructure card 302 that communicates with the CPU 314 using the computing BUS 303. The CPU 314 may execute a compute environment 304 that includes an execution environment 356 and a virtual switch 306. The computing environment 304 may provide the host function 309. The networking processing infrastructure card 302 may execute a network processing environment 305, which may also provide the host function 310 and a virtual network switch 307. The computing environment 304 and the network processing environment 305 may serve as software layer as part of a virtualization plane. The frame-based agent (slow agent) 320 may be implemented in various locations such as the execution environment 356, virtual switch 306, CPU 314, and virtual network switch 307. The frame-based agent (slow agent) 320 may run at less than line rate speeds if desired.

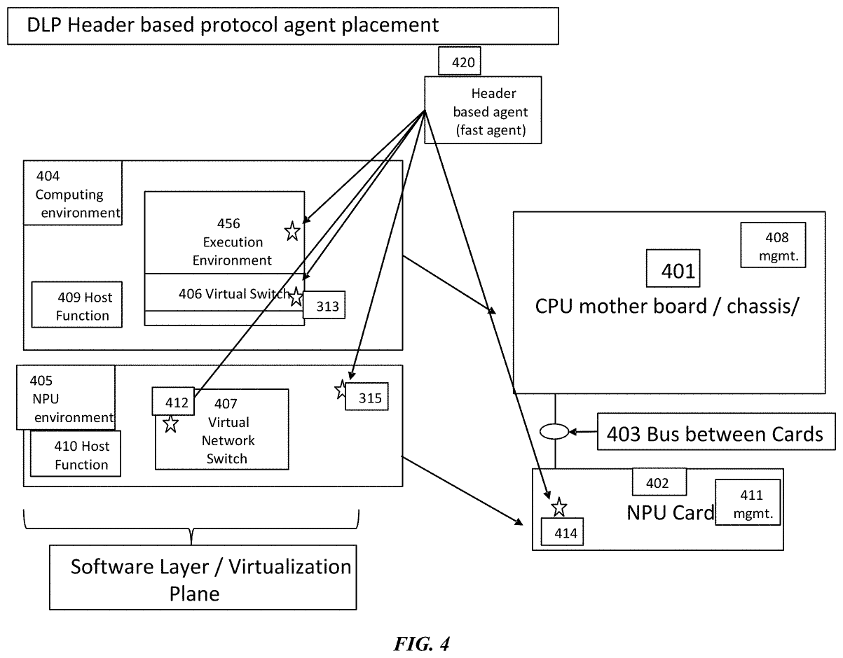

FIG. 4 is block diagram illustrating how a header-based agent (fast agent) may be implemented in a host computing system, according to an embodiment. The host computing system may include mother board and chassis 401 and CPU. The host computing system may also include a network processing infrastructure card 402 that communicates with the CPU using the computing BUS 403. The CPU may execute a compute environment 404 that includes an execution environment 456 and a virtual switch 406. The computing environment 404 may provide the host function 409. The networking processing infrastructure card 402 may execute a network processing environment 405, which may also provide the host function 410 and a virtual network switch 407. The computing environment 404 and the network processing environment 405 may serve as software layer as part of a virtualization plane. The header-based agent (fast agent) 420 may be implemented in various locations such as the execution environment 456, virtual switch 406, NPU 402, and virtual network switch 407. Optionally the header-based agent (fast agent) 420 can be implemented at any one of the locations show in FIG. 4 provided header-based agent (fast agent) 420 can provide frame insertion that matches the line rate of the links being supported. This may be in any type of processing unit, ASIC, Programmable silicon, etc. as long as it inserts frames at line rates.

Computing and device platforms use slow agent 320 and the fast agent 420 to compensate for lower cost performance, and higher performance needs. In general, dedicated ASIC (Application Specific Integrated Circuits) or circuits may be dedicated to a specific functional role, or if the system is fast enough those may be supported by the operating system, or the virtualization layer(s).

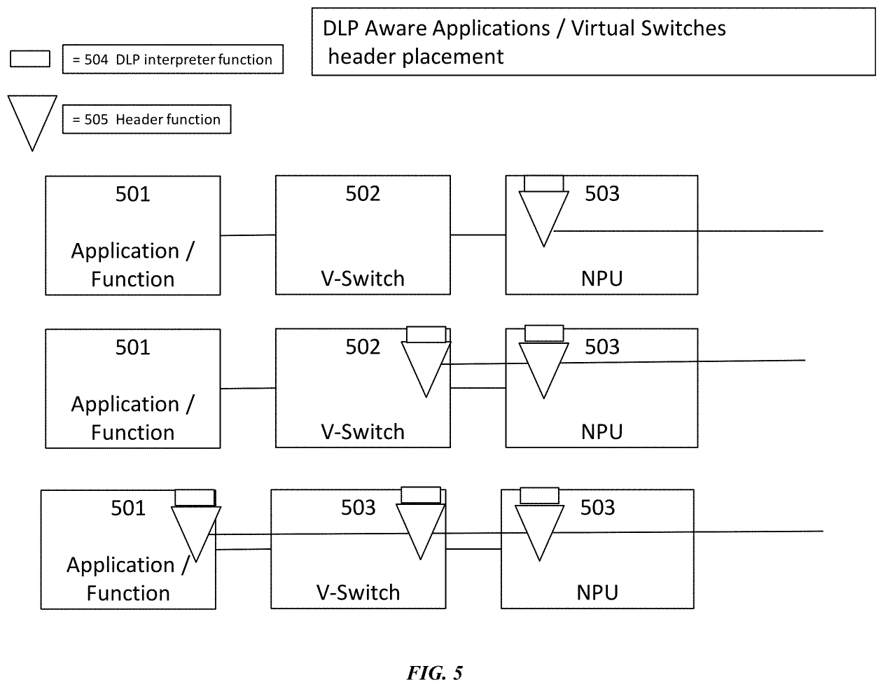

FIG. 5 is a flow diagram illustrating where a DLP header function and a fast agent may be implemented in a host computing system, according to an embodiment. The host computing system may include various layers such as a network layer 503 that is controlled and run by an NPU, an application layer 501 for software application, and a virtual switch layer 502 in between to facilitate the communications between the network layer 503 and the application layer 501. In some embodiments, the interpreter function 504 and the header function 505 may be implemented only at the network layer, such as at the NPU 503. In another embodiment, the interpreter function 504 and the header function 505 may be implemented at both the network layer 503 and the virtual switch layer 502. In yet another embodiment, the interpreter function 504 and the header function 505 may be implemented at all three layers. When the interpreter function 504 and the header function 505 are implemented at a layer, the layer becomes DLP aware. For example, in the last example, both the applications and the virtual switch are DLP aware.

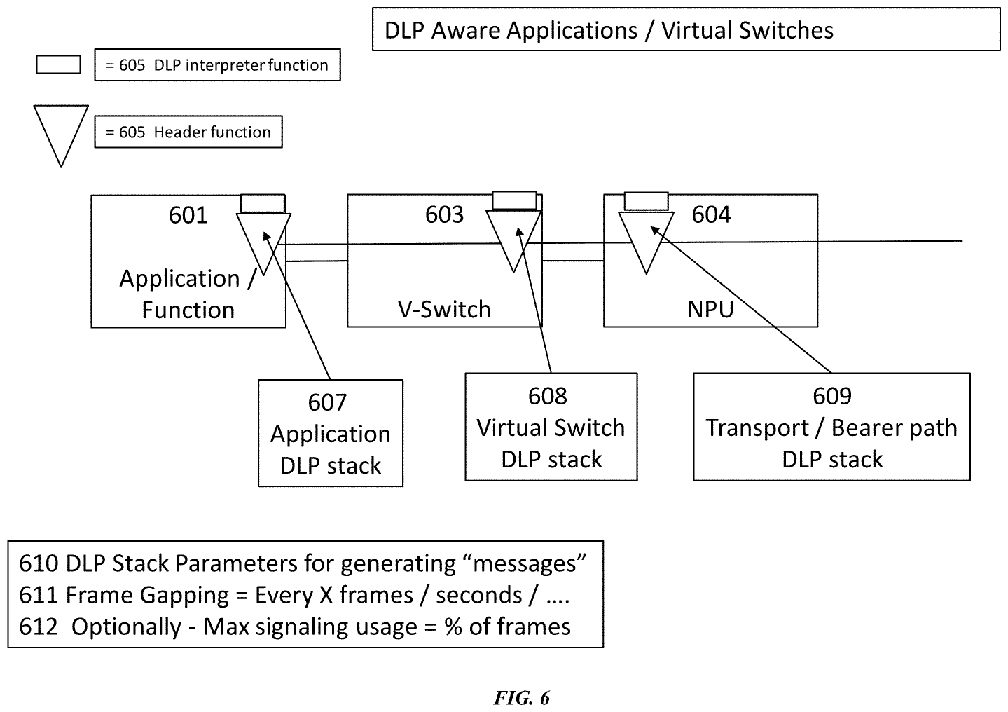

FIG. 6 is a block diagram illustrating DLP stack parameters for generating messages in DLP aware applications or DLP aware virtual switches, according to an embodiment. For an application layer 601 that is aware of DLP and may use DLP to put data in a DLP header. If the application layer is placing data in a DLP header, the computing host may reserve some of the transmission frames to be used by subsequent applications, virtual switches, or other DLP agents that are in-line on the same flow. The reservation of transmission frames may be accomplished by the DLP agent, which regulates how many DLP header frames may contain control messages from the application layer. An example form of setting for the DLP stack in the application layer is shown in 610 and 611 as gapping or percentage of frames that the application may use to send application based DLP messages through the DLP flow. Some frames are transmitted without any application based DLP messages to free the capacity of the overall DLP frames up for use by other DLP agents and applications on the same path. If a software application is DLP aware, the application may transmit DLP header messages directly to a network node to ask for missing information. The software application may also be aware of the state of the network directly. Conventionally, if the application is not DLP aware, the application may sit idle waiting for a missing payload without control of the network until timeout. When the software application or the virtual switch is DLP aware, the application or the virtual switch may directly send a DLP header message to other nodes to ask for the missing payload.

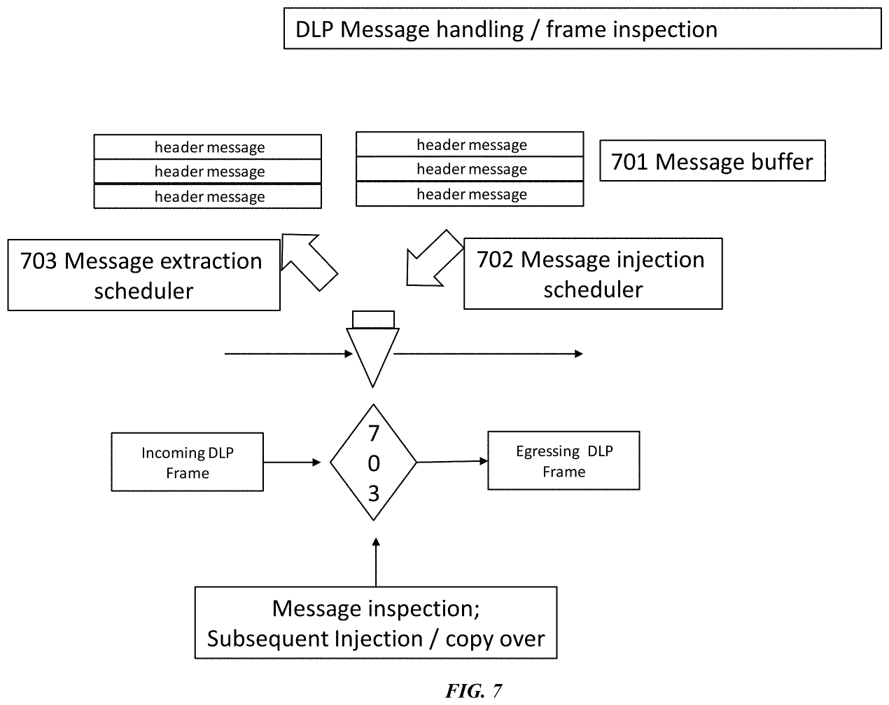

FIG. 7 is a block diagram illustrating an example process for DLP message handling and frame inspection, according to an embodiment. The message handling and frame inspection may be performed by a DLP header function. FIG. 7 depicts the behavior of the DLP header function when DLP is used across multiple applications or multiple transmission functions where some frames already contain messages. The header function includes a message injection function 702 and message extraction function 703. While some frames already contain messages, additional messages may come in from other host elements via the message buffer 701. The additional messages may be queued for transmission over the DLP headers that are available via a message injection function 702. Agents removing or copying messages off the bi-directional message flow are handled by a message extraction function 703. The messages are mapped to the appropriate source. For example, the header function receives an incoming DLP frame. The message extract function 703 determines whether there are messages in the header that are intended for the instant computing node. If so, the message extract function 703 extracts the message from the header. The header function also examines if there are available spaces in the header. The spaces become available if a message is extracted from the header or if the header is not in full capacity. In turn, the message injection function 702 injects a new message to the DLP frame and transmits the frame to a subsequent computing node.

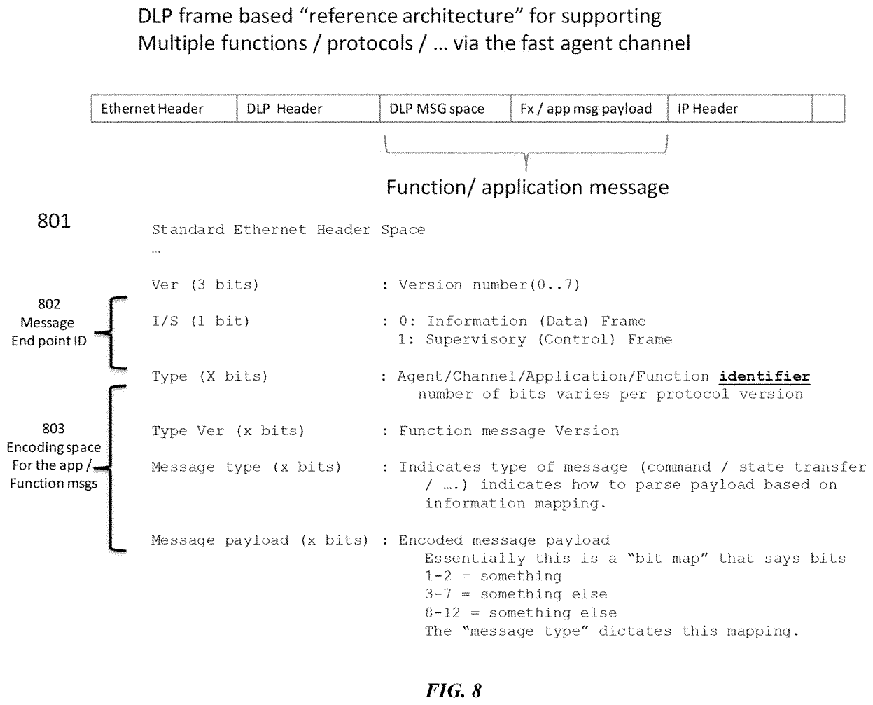

FIG. 8 depicts an example content of the DLP frame, which may include header message, functions and application messages, according to an embodiment. The DLP frame may be transmitted by a fast agent. In some embodiments, the frames are Ethernet so they have standard Ethernet header structure 801, but without a payload. The DLP frame may be used to send a control message. Since the DLP frame may have only the header, the frame can be transmitted as quickly as possible, such as under the line rate of the network. Each frame contains message information 802 that relates to the type of message. Each frame may also include the function messages or the application messages 803. Function messages or application message 803 are messages sent from a host function or an application. There can be various encoding, encapsulation, versioning, and protocol methods. The system uses a fast agent as a transmission facility to applications, management, control, etc. In some embodiments, the system does not use the IP/TCP layers that often have jitter buffers and slow re-transmission that is not sufficient for the control of time sensitive systems. It should be noted that the fast agent can also generate a frame-based message in a standard protocol packet creation fashion and insert it in the bearer path at line rate. The function message or application message may be included in the header of the frame.

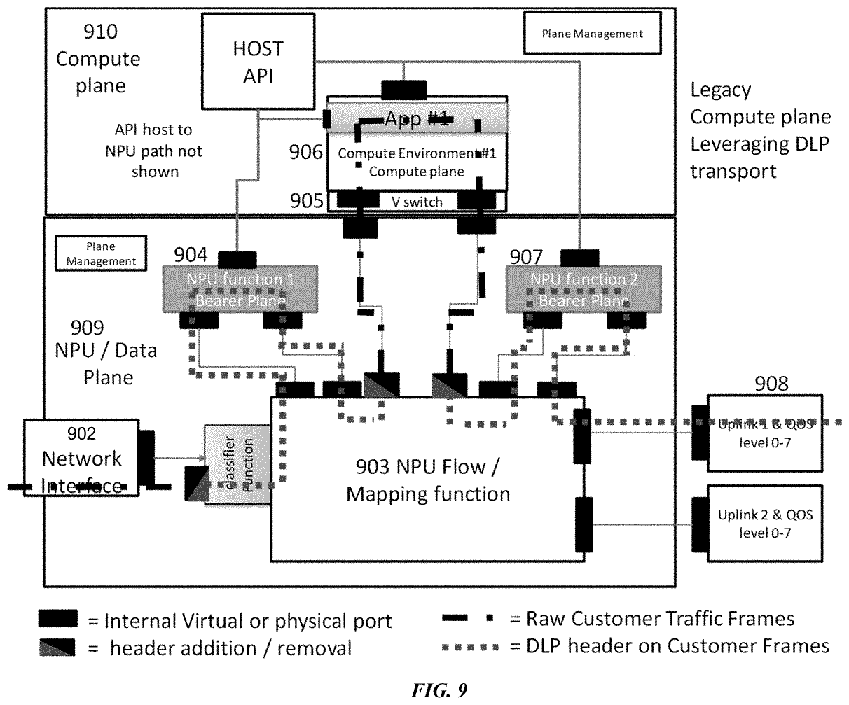

FIG. 9 is a single-node view of the implementation of the DLP protocol at an NPU or a switch layer of a host, according to an embodiment. Network traffic such as a DLP frame enters a computing node via network interface 902. A DLP-capable NPU or DLP-capable switch (commonly referred to as DLP switch) 903 receives the DLP frame. The DLP switch 903 performs classification and DLP header functions. The DLP switch 903 in turn routes the traffic to a DLP traffic function 904. The DLP frame returns to the DLP switch 903 after the DLP traffic function 904 performs QoS and ARQ related tasks. The DLP switch 903 provides the message an application 906 by removing the DLP header, transmitting the DLP frame to the virtual switch 905 and receiving the bi-directional Ethernet frame in the same path. The Ethernet frame may include an additional application message that needs to be transmitted to the next node. The message may be generated based on data from the host API. DLP switch 903 places a newly generated DLP header around the DLP frame. The DLP switche provides the DLP frame to another traffic function 907. The new DLP frame is transmitted to an uplink WAN or LAN path 908. By using this process, the DLP link technology is available on both the LAN/WAN or east and west side of a legacy computing host. Also, the DLP link technology only appears in the transport infrastructure layer of the computing node. Notably, in some embodiments, the NPU data plane 909 can be physically separate from the computing node 910 and be an external supporting device. The external NPU data plane 909 still provides transmission connection resiliency to the computing node as a standalone or combined host, platform or device. In the example shown in FIG. 9, the application and virtual switch are not DLP aware. The NPU is responsible for header addition and removal of the DLP frame and controls the traffic for the application.

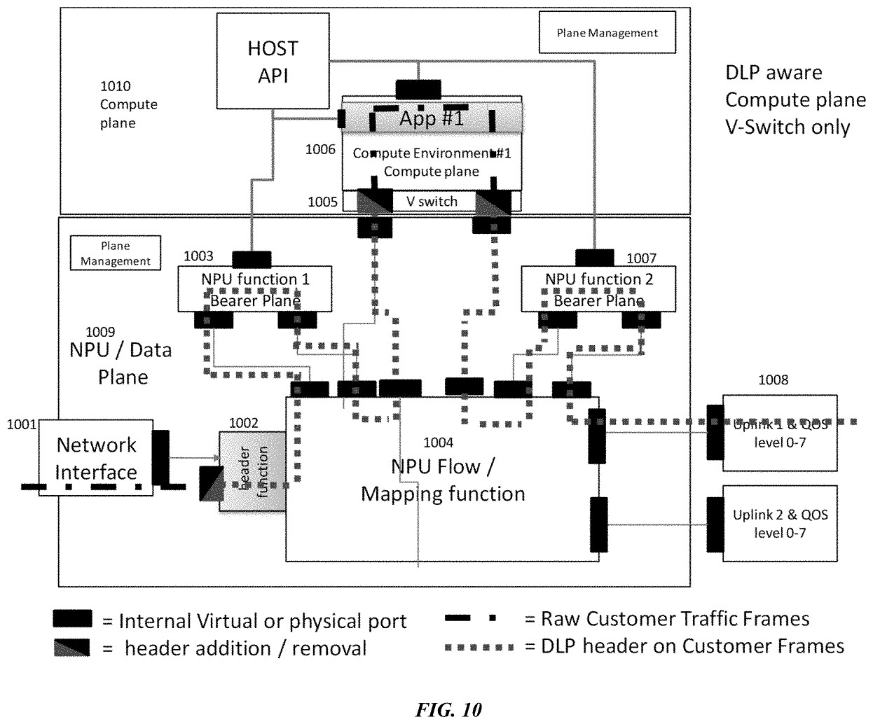

FIG. 10 shows the DLP header mapping functions available in both the virtual switch and the NPU. FIG. 10 shows an implementation which enables the application to directly use the fast agent path in FIG. 2C without using a message BUS implementation through the virtual switch. Furthermore, the states of the DLP path are now part of the application memory space and may be accessed at CPU speed, which significantly improves the speed at which actions can be taken when line conditions change. The header of a frame may be added or removed at the virtual switch 1005 and the classifier function 1002. In FIG. 9, the header of a frame is added or removed at the NPU. In FIG. 10, the header of a frame is added or removed at the virtual switch, which enables the application to directly use the fast agent through the virtual switch.

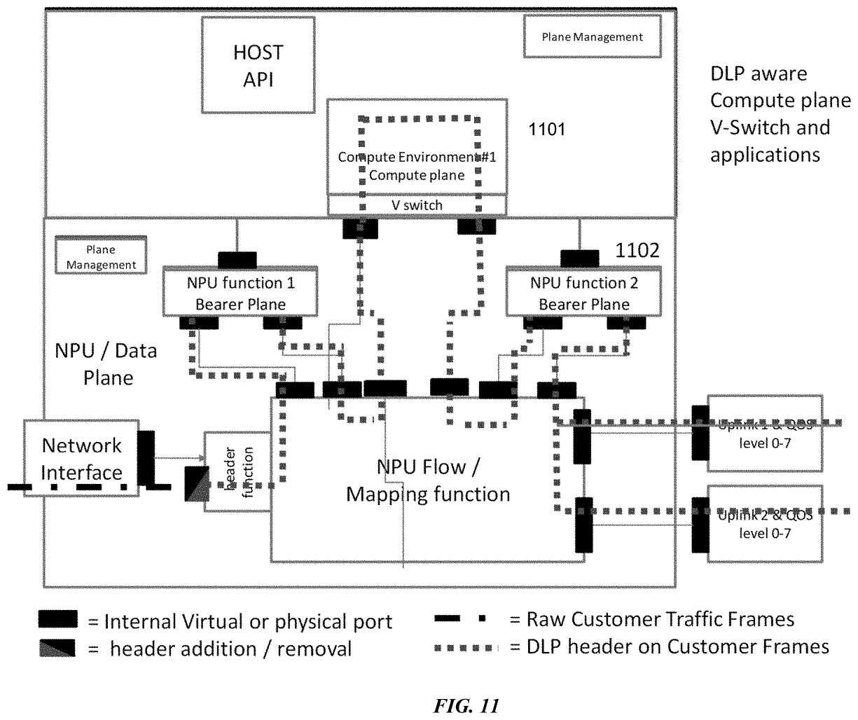

FIG. 11 shows a DLP-aware compute plane virtual switch and applications, according to an embodiment. Application 1101 places a DLP header on each frame the computing node transmits. The transmission control function 1102 may seamlessly conduct flow replication over multiple paths and path-based retransmission via DLP ARQ. This divides the amount of work being performed at each layer, provides applications with the fastest possible control signaling and state information, and allows the system to use multiple types of access/WAN/LAN from different providers to solve the resiliency problems experienced when moving applications from TDM to frame and packet-based technologies.

### Computing Machine Architecture

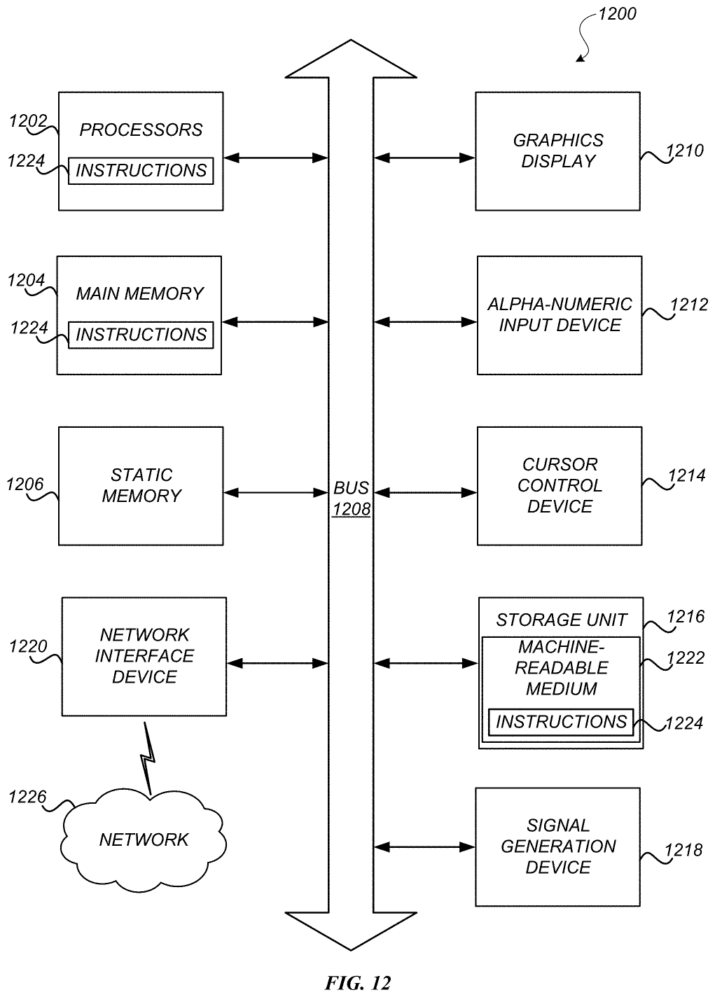

FIG. 12 is a block diagram illustrating components of an example computing machine that is capable of reading instructions from a computer-readable medium and executing them in a processor (or controller). A computer described herein may include a single computing machine shown in FIG. 12, a virtual machine, a distributed computing system that includes multiple nodes of computing machines shown in FIG. 12, or any other suitable arrangement of computing devices.

By way of example, FIG. 12 shows a diagrammatic representation of a computing machine in the example form of a computer system 1200 within which instructions 1224 (e.g., software, program code, or machine code), which may be stored in a computer-readable medium for causing the machine to perform any one or more of the processes discussed herein may be executed. In some embodiments, the computing machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The structure of a computing machine described in FIG. 12 may correspond to any software, hardware, or combined components shown in FIGS. 1 and 2A, including but not limited to, the telecommunication network administrator device 142, the network management system 130, various engines and agents shown in FIG. 2, and various computing nodes. While FIG. 12 shows various hardware and software elements, each of the components described in FIGS. 1 and 2 may include additional or fewer elements.

By way of example, a computing machine may be a personal computer (PC), a tablet PC, a set-top box (STB), a personal digital assistant (PDA), a cellular telephone, a smartphone, a web appliance, a network router, an internet of things (IoT) device, a switch or bridge, or any machine capable of executing instructions 1224 that specify actions to be taken by that machine. Further, while only a single machine is illustrated, the term “machine” and “computer” may also be taken to include any collection of machines that individually or jointly execute instructions 1224 to perform any one or more of the methodologies discussed herein.

The example computer system 1200 includes one or more processors 1202 such as a CPU (central processing unit), a network processing unit (NPU), a GPU (graphics processing unit), a TPU (tensor processing unit), a DSP (digital signal processor), a system on a chip (SOC), a controller, a state equipment, an application-specific integrated circuit (ASIC), a field-programmable gate array (FPGA), or any combination of these. Parts of the computing system 1200 may also include a memory 1204 that store computer code including instructions 1224 that may cause the processors 1202 to perform certain actions when the instructions are executed, directly or indirectly by the processors 1202. Instructions can be any directions, commands, or orders that may be stored in different forms, such as equipment-readable instructions, programming instructions including source code, and other communication signals and orders. Instructions may be used in a general sense and are not limited to machine-readable codes. One or more steps in various processes described may be performed by passing through instructions to one or more multiply-accumulate (MAC) units of the processors.

One and more methods described herein improve the operation speed of the processors 1202 and reduces the space required for the memory 1204. For example, the processing techniques described herein may reduce the complexity of the computation of the processors 1202 by applying one or more novel techniques that simplify the steps in generating results of the processors 1202. The processors described herein also speed up the processors 1202 and reduce the storage space requirement for memory 1204.

The performance of certain of the operations may be distributed among the more than processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations. Even though in the specification or the claims may refer some processes to be performed by a processor, this should be construed to include a joint operation of multiple distributed processors.

The computer system 1200 may include a main memory 1204, and a static memory 1206, which are configured to communicate with each other via a bus 1208. The computer system 1200 may further include a graphics display unit 1210 (e.g., a plasma display panel (PDP), a liquid crystal display (LCD), a projector, or a cathode ray tube (CRT)). The graphics display unit 1210, controlled by the processors 1202, displays a graphical user interface (GUI) to display one or more results and data generated by the processes described herein. The computer system 1200 may also include alphanumeric input device 1212 (e.g., a keyboard), a cursor control device 1214 (e.g., a mouse, a trackball, a joystick, a motion sensor, or other pointing instrument), a storage unit 1216 (a hard drive, a solid state drive, a hybrid drive, a memory disk, etc.), a signal generation device 1218 (e.g., a speaker), and a network interface device 1220, which also are configured to communicate via the bus 1208.

The storage unit 1216 includes a computer-readable medium 1222 on which is stored instructions 1224 embodying any one or more of the methodologies or functions described herein. The instructions 1224 may also reside, completely or at least partially, within the main memory 1204 or within the processor 1202 (e.g., within a processor's cache memory) during execution thereof by the computer system 1200, the main memory 1204 and the processor 1202 also constituting computer-readable media. The instructions 1224 may be transmitted or received over a network 1226 via the network interface device 1220.

While computer-readable medium 1222 is shown in an example embodiment to be a single medium, the term “computer-readable medium” should be taken to include a single medium or multiple media (e.g., a centralized or distributed database, or associated caches and servers) able to store instructions (e.g., instructions 1224). The computer-readable medium may include any medium that is capable of storing instructions (e.g., instructions 1224) for execution by the processors (e.g., processors 1202) and that cause the processors to perform any one or more of the methodologies disclosed herein. The computer-readable medium may include, but not be limited to, data repositories in the form of solid-state memories, optical media, and magnetic media. The computer-readable medium does not include a transitory medium such as a propagating signal or a carrier wave.

### Additional Considerations

In some embodiments, a computer-implemented method for implementing a telecommunication network protocol in an application layer is described. The computer-implemented method may include establishing, at an application layer, data traffic between a first data link protocol (DLP) node and a second DLP node, each DLP node implemented at a processor, a virtual switch, or a software application, each DLP node comprising a slow agent and a fast agent, the slow agent configured to transmit data payloads through Ethernet frames and the fast agent configured to transmit control messages through DLP frames, each DLP frame comprising a header only without a payload and the header carrying a control message. The computer-implemented method may include determining, at the software application of the first DLP node, that the data traffic between the first and second DLP nodes needs a control message. The computer-implemented method may further include generating the control message at the application layer. The computer-implemented method may further include injecting the control message to the header of a DLP frame, wherein the DLP frame does not include the payload. The computer-implemented method may further include transmitting the DLP frame from the first DLP node to the second DLP node.

In some embodiments, the first DLP node and the second DLP node are manageable through a cloud portal and automated through an orchestration or a software defined network controller.

In some embodiments, the DLP node's functionality is implemented as an application specific integrated circuit in the processor or implemented in a network card.

In some embodiments, the DLP node's functionality is implemented as a software protocol in a physical switch or the virtual switch in a host operating system.

In some embodiments, the software application is capable of acting as the first DLP node and generating the DLP frame directly.

In some embodiments, the software application is limited to a portion of capacity of a path used by the fast agent to preserve the capacity for other nodes.

In some embodiments, the software application of the second DLP node is an application that is not capable of handling DLP protocol, and wherein the virtual switch or the processor interprets the DLP frame on behalf of the software application.

In some embodiments, the software application of the second DLP node is capable of using the DLP protocol through the virtual switch or the processor.

In some embodiments, the DLP frame is injected into traffic of the Ethernet frames, and wherein the DLP frame is treated as an Ethernet frame but without the payload.

In some embodiments, the control message indicates that a particular data payload needs to be retransmitted to the software application of the first DLP node, and wherein the control message is sent based on an instruction from the software application of the first DLP node.

In some embodiments, the first DLP node is implemented on a cloud firewall node.

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Any feature mentioned in one claim category, e.g. method, can be claimed in another claim category, e.g. computer program product, system, storage medium, as well. The dependencies or references back in the attached claims are chosen for formal reasons only. However, any subject matter resulting from a deliberate reference back to any previous claims (in particular multiple dependencies) can be claimed as well, so that any combination of claims and the features thereof is disclosed and can be claimed regardless of the dependencies chosen in the attached claims. The subject-matter may include not only the combinations of features as set out in the disclosed embodiments but also any other combination of features from different embodiments. Various features mentioned in the different embodiments can be combined with explicit mentioning of such combination or arrangement in an example embodiment or without any explicit mentioning. Furthermore, any of the embodiments and features described or depicted herein may be claimed in a separate claim and/or in any combination with any embodiment or feature described or depicted herein or with any of the features.

Some portions of this description describe the embodiments in terms of algorithms and symbolic representations of operations on information. These operations and algorithmic descriptions, while described functionally, computationally, or logically, are understood to be implemented by computer programs or equivalent electrical circuits, microcode, or the like. Furthermore, it has also proven convenient at times, to refer to these arrangements of operations as engines, without loss of generality. The described operations and their associated engines may be embodied in software, firmware, hardware, or any combinations thereof.

Any of the steps, operations, or processes described herein may be performed or implemented with one or more hardware or software engines, alone or in combination with other devices. In some embodiments, a software engine is implemented with a computer program product comprising a computer-readable medium containing computer program code, which can be executed by a computer processor for performing any or all of the steps, operations, or processes described. The term “steps” does not mandate or imply a particular order. For example, while this disclosure may describe a process that includes multiple steps sequentially with arrows present in a flowchart, the steps in the process do not need to be performed by the specific order claimed or described in the disclosure. Some steps may be performed before others even though the other steps are claimed or described first in this disclosure. Likewise, any use of (i), (ii), (iii), etc., or (a), (b), (c), etc. in the specification or in the claims, unless specified, is used to better enumerate items or steps and also does not mandate a particular order.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein. In addition, the term “each” used in the specification and claims does not imply that every or all elements in a group need to fit the description associated with the term “each.” For example, “each member is associated with element A” does not imply that all members are associated with an element A. Instead, the term “each” only implies that a member (of some of the members), in a singular form, is associated with an element A. In claims, the use of a singular form of a noun may imply at least one element even though a plural form is not used.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights.

What is claimed is:

1. A computer-implemented method for implementing a telecommunication network protocol in an application layer, the computer-implemented method comprising:
establishing, at an application layer, data traffic between a first data link protocol (DLP) node and a second DLP node, each DLP node implemented at a processor, a virtual switch, or a software application, each DLP node comprising a slow agent and a fast agent, the slow agent configured to transmit data payloads through Ethernet frames and the fast agent configured to transmit control messages through DLP frames, each DLP frame comprising a header only without a payload and the header carrying a control message;
determining, at the software application of the first DLP node, that the data traffic between the first and second DLP nodes needs a control message;
generating the control message at the application layer;
injecting the control message to the header of a DLP frame, wherein the DLP frame does not include the payload; and
transmitting the DLP frame from the first DLP node to the second DLP node.

2. The computer-implemented method of claim 1, wherein the first DLP node and the second DLP node are manageable through a cloud portal and automated through an orchestration or a software defined network controller.

3. The computer-implemented method of claim 1, wherein the DLP node's functionality is implemented as an application specific integrated circuit in the processor or implemented in a network card.

4. The computer-implemented method of claim 1, wherein the DLP node's functionality is implemented as a software protocol in a physical switch or the virtual switch in a host operating system.

5. The computer-implemented method of claim 1, wherein the software application is capable of acting as the first DLP node and generating the DLP frame directly.

6. The computer-implemented method of claim 1, wherein the software application is limited to a portion of capacity of a path used by the fast agent to preserve the capacity for other nodes.

7. The computer-implemented method of claim 1, wherein the software application of the second DLP node is an application that is not capable of handling DLP protocol, and wherein the virtual switch or the processor interprets the DLP frame on behalf of the software application.

8. The computer-implemented method of claim 7, wherein the software application of the second DLP node is capable of using the DLP protocol through the virtual switch or the processor.

9. The computer-implemented method of claim 1, wherein the DLP frame is injected into traffic of the Ethernet frames, and wherein the DLP frame is treated as an Ethernet frame but without the payload.

10. The computer-implemented method of claim 1, wherein the control message indicates that a particular data payload needs to be retransmitted to the software application of the first DLP node, and wherein the control message is sent based on an instruction from the software application of the first DLP node.

11. The computer-implemented method of claim 1, wherein the first DLP node is implemented on a cloud firewall node.

12. A system comprising:
a first data link protocol (DLP) node and a second DLP node, each DLP node implemented at a processor, a virtual switch, or a software application, each DLP node comprising a slow agent and a fast agent, the slow agent configured to transmit data payloads through Ethernet frames and the fast agent configured to transmit control messages through DLP frames, each DLP frame comprising a header only without a payload and the header carrying a control message, wherein the first DLP node is configured to:
establish, at an application layer, data traffic with the second DLP node,
determine, at the software application, that the data traffic needs a control message,
generate the control message at the application layer,
inject the control message to the header of a DLP frame, wherein the DLP frame does not include the payload, and
transmit the DLP frame from the first DLP node to the second DLP node.

13. The system of claim 12, wherein the first DLP node and the second DLP node are manageable through a cloud portal and automated through an orchestration or a software defined network controller.

14. The system of claim 12, wherein the DLP node's functionality is implemented as an application specific integrated circuit in the processor or implemented in a network card.

15. The system of claim 12, wherein the DLP node's functionality is implemented as a software protocol in a physical switch or the virtual switch in a host operating system.

16. The system of claim 12, wherein the software application is capable of acting as the first DLP node and generating the DLP frame directly.

17. The system of claim 12, wherein the software application is limited to a portion of capacity of a path used by the fast agent to preserve the capacity for other nodes.

18. The system of claim 12, wherein the software application of the second DLP node is an application that is not capable of handling DLP protocol, and wherein the virtual switch or the processor interprets the DLP frame on behalf of the software application.

19. The system of claim 17, wherein the software application of the second DLP node is capable of using the DLP protocol through the virtual switch or the processor.

20. The system of claim 12, wherein the first DLP node is implemented on a cloud firewall node.
